(19) United States
(12) Patent Application Publication
(10) Pub. No.: US 2015/0302356 A1
(43) Pub. Date: Oct. 22, 2015

(54) SOCIAL MEDIA LIFE SKILLS MATCHING

(71) Applicant: Global Trading Associates, Raleigh, NC (US)

(72) Inventor: Mounib Aoun, Raleigh, NC (US)

(73) Assignee: GLOBAL TRADING ASSOCIATES, Raleigh, NC (US)

(21) Appl. No.: 14/323,567

(22) Filed: Jul. 3, 2014

Related U.S. Application Data
(60) Provisional application No. 61/980,916, filed on Apr. 17, 2014.

(51) Int. Cl. G06Q 10/10; G06Q 50/00

(52) U.S. Cl. CPC G06Q 10/1053; G06Q 50/01

(57) ABSTRACT

A social media site is disclosed for matching employers with people or workers having a particular life skill. The person or worker may or may not be looking for a job, or may never had a job related to a particular life skill, but such skill is searchable so an employer can find the best people for a job regardless if they are working or not.

This application claims priority of U.S. provisional application No. 61/980,916 filed on Apr. 17, 2014 and is incorporated in its entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a social media site and method of matching employers needing workers with people having particular life skills. In particular, it relates to a social media web-site which allows individuals to sign up regardless if they are looking for a job or not and allows prospective employers to view people with various life skills regardless if they are looking for a job or not. The social media site also lists jobs posted by employers.

2. Description of Related Art

The work of matching jobs offered by employers to prospective employees is as old as jobs themselves. Traditionally, jobs were advertised in written media, and prospective employees would answer the advertisement with a resume or at least some other form of inquiry. With the advent of the internet and computers, recruitment by employers has changed. Direct job postings still occur by the old news agencies, and places like Craigslist have popped up for direct employment advertising. The internet has existed now for some time and now more developed web-sites for employment have arisen such as Monster.com, Careerbuilder.com, and Jobs.com.

These employment systems in their most basic format include a database of job postings from employers seeking employees. The postings can include job criteria such as type of job, job criteria, job qualifications, salary, job location, and the like. They may also include the employer name, location, and contact information. The job candidate can then search the database trying to find jobs that meet their job criteria. Depending on the complexity of the job, the job searcher can search keywords and classifications along with other job criteria, and may also allow the job searcher to submit a resume or otherwise apply for the job.

Some of these systems allow the employer to look at a database of potential job candidates with data about the candidate such as name, personal information, contact information and employment history; job qualifications, career goals, desired job criteria, and even a resume. These systems allow employers similar searching of job candidates to determine if the candidates are a match for a particular position they have available. Most of the time the employer has to pay fees or a monthly subscription in order to view this data. In many incidents, for example in the pharmacy business, employers hire a recruiter just to find qualified candidates. In some hospitals, doctors pay up to 30% of their salaries for their recruiters. Most of the time, employers and employees pay a high premium for such recruitment. In some situations when employers subscribe to these sites in order to view potential candidates, the site does not give them all the candidates in their databases. They ration the amount of data a subscriber is receiving in order to keep his subscription going for the longest amount of time.

The biggest problem with the current systems is that these systems are directed at people looking to be employees, and tend to generate large numbers of candidates applying for jobs and responding to listings. The employer can be overwhelmed with candidates, many of which are less than desirable or just outright not qualified. The employer must sift through numerous applications, making it easy to miss good resumes and spend too much time on the wrong candidate. Furthermore, job searchers are not always looking on a regular basis for a job and may miss one employer's posting in favor of another posting. In addition, there may be problems with posting on one search site and the candidate searching on another site, making it difficult to match. Yet another problem is the lack of upfront references, which can help validate the worth of a particular candidate. In addition, the job opening could be for a part-time, contract, or volunteer type job. Currently, matching systems are not that good at allowing the employer to find all the available candidates for a particular job opening in an expeditious manner. The current job sites do not service part-time recruitment or job matching. Most people have a number of life skills, which include job skills, hobby skills, interest skills and the like, which together form life skills. Many of these life skills have no connection to any previous employment. There is a tremendous need to improve on the employer's ability to find the right candidate at the right time. In the current system, employers have to read through every resume that the site provides them in order to find an employee with a special skill. It is a very inefficient system that does not encourage use by either a potential employee or employer.

### BRIEF SUMMARY OF THE INVENTION

The present invention relates to the discovery that a social media type web-site where people with work skills, life skills, job seekers and non-job seekers alike, part or full-time job seekers, can interact with one another and establish relationships. And employers can interact as well, therefore allowing the employers to contact the best available candidates, whether those candidates are looking for a job, or are qualified for a job and not presently looking for a job. Employers can recruit potential candidates even while they are fully staffed, so when one of their employees depart, they have an immediate replacement or know where to find one. It also allows a form of referral system by seeing who the people have as their contacts. By being able to recruit people having a particular life skill (such as entertainment, cooking, martial arts, etc.) even if they are not currently looking for a job, it ends up not only improving the employer's ability to find the best candidate, but it also improves the income of the employee, since employers will know that now it is much easier to recruit a good employee away from their present employment if they are not in a happy situation or not being compensated well. It also allows one to hire someone with a particular life skill without previous work experience in that skill. With this new invention, employers and job seekers are easily connected without a third party intervention. They can easily communicate and make contact with one another. The system is free to the employer in one embodiment and the information is placed on a voluntary basis. This invention can be a great tool in the hand of employers who are seeking to open a factory or a production site in certain areas since it can allow them to find the area with the most qualified people for the job whether they are looking for a job or not. The site is designed to mainly help employers look for potential employees, but is a great aid to all workers looking for a job or not. Employers can always be casting over to the site to pick the most qualified employees. An employer can also find and interview people for potential positions before their business is even open without publicly advertising for the job. For example, take the case of a restaurant owner. He or she can look to hire most of their staff before they even build or open the restaurant. The site enables people with life skills or life experiences, other than those skills gained at a job, to post and offer these skills as services to others, who are looking for employees with such skills. The site is not only for people to post their skills, it is also a site for those looking for those skills. Therefore when people exchange their services, they have not spent any money on advertising their skills or their services, or setting up a store front to advertise such service. Since the service and the posting of information and skills are free to the public, this can influence the amount of money people will charge for such service. Basically, many of these services will become more affordable for employers.

Accordingly, in one embodiment the invention is a social media employment recruiting system comprising:
a) a server connected to the internet configured to accept a request from a plurality of users to join the social media system and having access to the server via a web-site;
b) a memory in the server storing historical life skills data of users who are job seekers;
c) a memory in the server storing historical life skills data of users who are non-job seekers;
d) a memory in the server storing a plurality of profiles of users who are employers;
e) a searching component designed to allow the users who are employers to search the historical life skills data of both users who are job seekers and users who are non-job seekers for finding a potential employee; and
f) a communication system that allows users on the social media system to contact one another.

In another embodiment there is a method for employers to find potential employees over the internet comprising:
a) establishing a social media web-site comprising:
   i. a server connected to the internet configured to accept a request from a plurality of users to join the social media system and having access to the server via a web-site;
   ii. a memory in the server storing historical life skills data of users who are job seekers;
   iii. a memory in the server storing historical life skills data of users who are non-job seekers;
   iv. a memory in the server storing a plurality of profiles of users who are employers;
   v. a searching component designed to allow the users who are employers to search the historical life skills data of both users who are job seekers and users who are non-job seekers for finding a potential employee; and
   vi. a communication system that allows users on the social media system to contact one another.
b) searching by employer user of historical work related profile data of users who are job seekers and non-job seekers;
c) determining which of the searched users could be potential employees; and
d) contacting the users determined to be potential employees.

In yet another embodiment, the present invention is a social media web-site having employers, job seekers and non-job seekers as members wherein the employers can view life skills of both the job seekers and non-job seekers and contact them regarding employment with the employer.

### BRIEF DESCRIPTION OF THE DRAWINGS

FIG. 1 is a relationship chart depicting the system of the present invention.

FIG. 2 is a flow chart of the method of the present invention.

FIG. 3 is a flow chart of the method job seekers and non-job seekers use to utilize the web-site of the present invention.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### DEFINITIONS

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitations thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “social media” refers to a web-site on which one or more users may post content related to job opportunities as well as other items normally related to social interaction on a web-site. Content generally refers to images, videos, comments or other text, date information, identification data, links, user profiles, or other data or information that may be posted or otherwise accessible on or from the social media site(s) especially relating to historical work-related profile data. The site can be accessed from a computer or smartphone directly at the web-site or, for example, by use of an app button.

As used herein the terms “job”, “job opening” and the like refer to an employer seeking someone to perform a particular task on a permanent, part-time or limited number of hours/days basis (e.g. a particular task). This can be for a classic employer/employee relationship, or it can be for a contractor or a volunteer (for example a charity event) or the like type of relationship. For the purposes of simplicity, unless otherwise noted, employee and employment relate to these various types of relationships whether classical employee/employer relationship or not. So an entertainer for a party, someone to clean up the yard, someone with hobby skills, life skills and the like will be within this set, as well as people with skills obtained just from work experience. Even daily labor can post their availability inside other sets

As used herein the term “life skills” are behaviors used appropriately and responsibly in the management of personal affairs. They are a set of human skills acquired via learning (e.g. school), through having been taught (again school, but also life experiences or interests), through job experience, teaching, psychological skills, language skills, accomplishments, personal interests, acquired skills or direct experience and the like that are all used to handle problems, interests and/or questions commonly encountered in daily human life. The subject varies greatly depending on the individual. It includes, but is not limited to, job skills acquired through experience in working in a particular field. So for example, an individual may have work experience in a pizza restaurant, but might also have experience dancing, singing, be accomplished in carpentry, gardening, won a writing award and also be athletic in a sport or athletic pursuit like running, some of which were not compensated as paying jobs. A pizza employer might need a delivery man, but also needs someone to constantly run up large flights of stairs, and then the life skill athleticism becomes relevant.

As used herein the term “employment” or “employees” and the like refer to anyone who could be engaged by an employer, or volunteer for free to do a particular job. It could be standard employment (wage, salary, etc.) full or part-time, but could also be contract work, volunteering, one time work or anything where an employer first group/person contacts and engages a second person for doing something for them. For example, employment could be working for a restaurant, cleaning out the garage, performing for a child's birthday, utilizing someone with a unique set of life skills and the like. Because previous job sites only cover work-related job skill experience, life skills in total are never considered until the present invention. So, in one example, a lawyer who can entertain, a carpenter good at poker, and the like, could be unusual combinations of job skills and other non-job life skills, which a potential employer could never find absent the present invention.

As used herein the term “employment recruiting system” refers to a system for putting together employers with both those looking for a job and those who might not be looking for a job, but could be enticed or recruited away from their job. The social media aspect of the employment recruiting system allows for potential employers and people with life skills to register and interact, regardless if the people are job hunting or not. By utilizing this form of recruiting system the employer is more in charge of the process and can research people on the site for all life skills (not just job skills), regardless if individuals have actually expressed an interest or not, or have, or think they have, the requisite experience and training for a particular job. An employer can find people with related life skill experience and quickly contact them with job opportunities and keep up to date the availabilities of workers. Likewise, potential employees can be in touch with other people and help them understand the marketplace they are operating within. Someone who is employed, and satisfied with their job, can post their skills. An employer or someone who is in need of such skills can reach out to that employed person, and hire them for a one-time job or consulting work, and pay them, and yet they can still retain their full-time employment elsewhere. The other important advantage is for people whose job skills or life skills match those who are seeking it, they are connected immediately by having a found signal communicated between them. This site will make jobs become commodities, and they will be obtained by the highest bidder. The site may also utilize a job reference book or a job dictionary to help with job matching.

As used herein the term “server connected to the internet” refers to a computer which includes a storage media for storing data, running software for a social media site, for communications and the like. The server allows members of the social media to access the social media web-site and members participating in the social media web-site employment recruiting system.

As used herein the term “configured to accept a request” refers to the social media web-site to accept requests of all kinds from users. These requests could be requests to join the social media site, having access to the server on a web-site, to interact with users to send e-mails, or otherwise communicate with users on the system. It also would allow the site to accept advertising to help pay for the system.

As used herein the term “user or users” refers to employers, employees, advertisers, and other individuals and the like who wish to utilize the social media web-site.

As used herein the term “historical life skills data” refers to life skill information about users, especially potential employees and those that could potentially be an employee (virtually anyone on the site). Specifically, any bits of life skill information about the individual that might aide an employer in identifying a user as a potential employee. So for example: job history, job expertise/experience, life experiences, education, interests, skills, hobbies, vocation, language, residence, personal data (like age, marital status and the like) can be included. One skilled in the art can fill in other important life skill data useful for this site. It is important that this list includes skills not found in general resumes (more than just job skills) and can be more inclusive than resumes.

As used herein the term “job seekers” refers to users on the site who are specifically looking for employment. The employment can be with a specific company, with a particular industry, employment in general, and the like.

As used herein the term “non-job seekers” refers to users of the social media site who at any given moment are not looking for employment but might be open to an employment opportunity if approached by an employer. Those people might never get contacted, or if they have an attractive background of historical work related profile data, they could receive many inquiries. This is especially true if someone is looking for a life skill not including job skills.

As used herein the term “searching component” refers to software in resident memory on the server that allows an employer using the searching component to search the historical life skill data of both users who are job seekers, and users who are non-job seekers, for finding a potential employee.

As used herein the term “potential employees” refers to any user, such as job seekers, non-job seekers and even other employers who could potentially be hired by an employer utilizing the system.

As used herein the term “communication system” refers to a system on the social media web-site for the purpose of users contacting one another. This is well within the skill in the art and includes chat, e-mail, video conferencing, voice chat, and the like.

As used herein the term “anonymously” refers to the ability of a user to present historical work-related profile data or employer data only to those that the user desires. In other words, either job seekers or employers can be kept anonymous to keep the job search process confidential.

As used herein the term “employment ad” refers to placing information on the social media web-site which indicates a job opening. An employment ad is within the skill in the art.

As used herein the term “self-deleting” refers to advertisements or any other data that have a time period after which the server deletes the information from being able to be viewed by a user. So, for example, an employment ad could be deleted after posting for a period of time.

As used herein the term “link as friends” refers to creating links to users that have a privilege not afforded to other users. The friend concept is well known within the social media users and friend's software is within the skill in the art.

As used herein the term “contact” refers to interaction utilizing the communication means of the social media system but can also be by conventional means such as phone, mail, video conference, e-mail and the like, which are not associated with the social media web-site.

As used herein the term “job opening” refers to the availability of employment with a particular employer. It refers to an employer attempting to find an employee to perform a particular task at the employer's place of work.

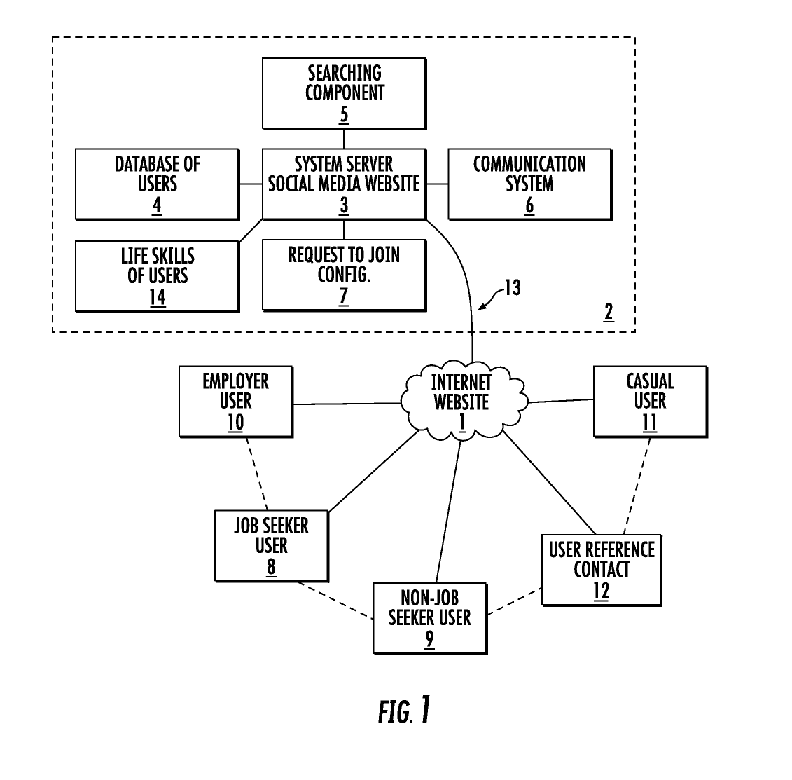

Now referring to the drawings, FIG. 1 is a relationship chart of the relationship of the elements of the present invention system. In this view an internet web-site 1 houses a social media site 2 on a system server 3. The social media site 2 comprises a database of users 4, a searching component for searching for users 5, and their profiles of life skill data 14, a communication system for communication between users 6 and software in resident memory on the server for allowing users to join the social media web-site 7. The users then can access the social media web-site via internet 1 and consist of a job seeker user 8, a non-job seeker user 9, and employer user 10, a casual user (non-employer or job seeker) 11, and reference contact users 12. Users are connected via communication system 6, provided on the system server 3 via the communication system 6.

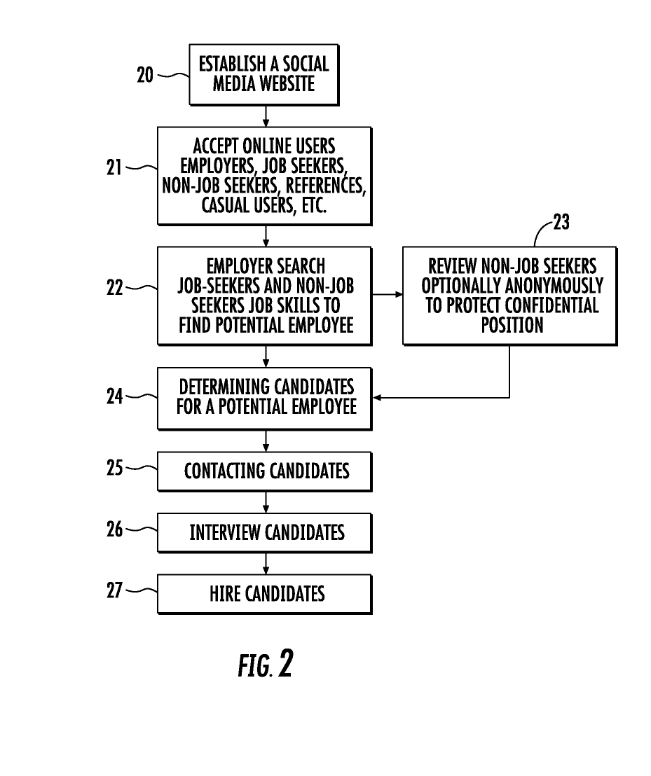

FIG. 2 is a flow chart of an embodiment of the present invention method. In this figure a social media web-site is established 20, which provides contact for employers and employees as discussed and explained above. The web-site 20 can accept online users of the social media web-site including employers, job seekers, non-job seekers, references, casual users and the like 21. Employers searching for people to fill job positions can then search job seekers and non-job seekers alike with life skills to find and contact potential employees 22. The employer can them review the desired job seekers and non-job seekers either openly or anonymously on the social media site to see their interest in a job position 23. The employer can them determine which candidate they reviewed are candidates for the job position opening 24 and contact the candidates 25 for an interview 26 or directly offer them a job. The employer can then hire the accepting candidate 27.

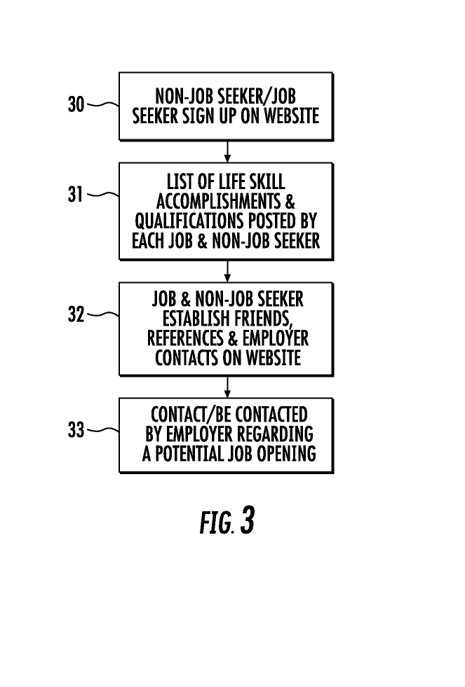

FIG. 3 is a flow chart of the use by workers/employees of the social media web-site. The non-job seeker, worker, and job seeker workers sign up on the web-site 30 and establish themselves, upload life skills data, resumes, references and the like 31. Friends, further references, employer contacts are made on the web-site 32. Finally, the non-job seeker and job seeker alike can contact or be contacted by a potential employer for a potential job opening/opportunity 33.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like, apparent to those skilled in the art, still fall within the scope of the invention as claimed by the Applicant.

What is claimed is:

1. A social media employment recruiting system comprising
a) a server connected to the internet configured to accept a request from a plurality of users to join the social media system and having access to the server via a web-site;
b) a memory in the server storing historical life skills data of users who are job seekers;
c) a memory in the server storing historical life skills data of users who are non-job seekers;
d) a memory in the server storing a plurality of profiles of users who are employers;
e) a searching component designed to allow the users who are employers to search the historical life skills data of both users who are job seekers and users who are non-job seekers for finding a potential employees; and
f) a communication system that allows users on the social media system to contact one another.

2. The social media system according to claim 1 wherein a user can contact another user anonymously.

3. The social media system according to claim 2 wherein the anonymous user is at least one of the group consisting of a job seeker and a non-job seeker.

4. The social media system according to claim 2 wherein the anonymous user is an employer.

5. The social media system according to claim 1 wherein the employer has an employment ad posted on the social media system.

6. The social media system according to claim 1 wherein the employment ad is self-deleting on an expiration date.

7. The social media system according to claim 1 wherein users can link as friends.

8. The social media system according to claim 7 wherein employers can view the friends of a potential employee.

9. The social media system according to claim 1 wherein employer users can contact non-job seekers regarding a job opening.

10. A method for employers to find potential employees over the internet comprising:
a) establishing a social media web-site comprising:
i. a server connected to the internet configured to accept a request from a plurality of users to join the social media system and having access to the server via a web-site;
ii. a memory in the server storing historical life skills data of users who are job seekers;
iii. a memory in the server storing historical life skills data of users who are non-job seekers;
iv. a memory in the server storing a plurality of profiles of users who are employers;
v. a searching component designed to allow the users who are employers to search the historical life skills data of both users who are job seekers and users who are non-job seekers for finding a potential employees; and
vi. a communication system that allows users on the social media system to contact one another.
b) searching by employer user of historical life skill data of users who are job seekers and non-job seekers;
c) determining which of the searched users could be potential employees; and
d) contacting the users determined to be potential employees.

11. The method according to claim 10 wherein the users are linked to one or more friends.

12. The method according to claim 11 wherein the employer views the friends of the potential employees.

13. The method according to claim 10 wherein users post one or more references of individuals who are also users on the social media web-site.

14. The method according to claim 10 wherein the contacted user is a non-job seeker.

15. The method according to claim 14 wherein the employer anonymously contacts the non-job seeker.

16. The method according to claim 10 which further comprises references of users becoming users of the social media system.

17. The method according to claim 10 wherein a user connects to the web-site via an app.

18. A social media web-site having employers, job seekers and non-job seekers as members wherein the employers can view life skills of both the job seekers and non-job seekers and contact them regarding employment with the employer.
